(19) United States
(12) Patent Application Publication
(10) Pub. No.: US 2024/0117502 A1
(43) Pub. Date: Apr. 11, 2024

(54) COMPOUND DECOMPOSING DEVICES AND METHODS USING RESONANCE OF ELECTROMAGNETIC WAVES

(71) Applicant: Myeong-Eun HWANG, Seoul (KR)

(72) Inventor: Myeong-Eun HWANG, Seoul (KR)

(21) Appl. No.: 17/962,578

(22) Filed: Oct. 10, 2022

(51) Int. Cl. C25B 1/04; C25B 9/19; C25B 9/50; C25B 9/65

(52) U.S. Cl. CPC C25B 1/04; C25B 9/19; C25B 9/50; C25B 9/65

(57) ABSTRACT

Disclosed herein are methods and apparatuses for producing hydrogen and oxygen from water, or for producing less-complex constituents from a more-complex compound, more particularly, for decomposing chemical bonds of a compound using resonant electromagnetic (EM) waves such as sunlight.

### FIELD

The present disclosure relates to apparatuses and methods for decomposing a compound, and more particularly, to apparatuses and methods for decomposing a chemical bond of the compound using the resonance effect of electromagnetic (EM) waves such as solar EM waves.

### BACKGROUND

Hydrogen in its natural state exists in many types of hydrogen compounds by combining with other elements. Conventional methods for separating pure hydrogen from the compounds like steam reforming, pyrolysis, and water electrolysis, are used.

Steam reforming usually extracts hydrogen by reacting a hydrocarbon compound such as natural gas with steam, and has the advantages of low carbon dioxide production rate and obtaining a large amount of hydrogen from a certain amount of hydrocarbon compound, but the process temperature is near 950° C. or higher. Therefore, the process has the disadvantage of consuming a lot of energy.

Pyrolysis is a method of separating hydrogen by decomposing natural gas at a high temperature. Pyrolysis has advantages such as producing hydrogen without carbon dioxide and obtaining high-purity carbon black as a by-product, but because the reaction temperature is high, a high-temperature valve must be used and the reactor control is complicated.

Water electrolysis is a hydrogen production method known for a long time and has the advantage of being highly reliable and easy to obtain high-purity hydrogen, but it has the disadvantage of high production cost due to low energy efficiency and current density, and corrosion resistance to prevent corrosion of equipment by electrolyte.

Accordingly, there has been a need for a new type of hydrogen production method capable of producing a large amount of high-purity hydrogen at a low cost while compensating for the disadvantages of the conventional hydrogen production methods.

### SUMMARY

At least one goal of the present disclosure is to provide apparatuses and methods capable of yielding a large amount of hydrogen gas and its by-products at a low cost by splitting a chemical bond of a hydride (e.g., water) with EM resonant waves.

Another goal of the present disclosure is to provide apparatuses and methods capable of decomposing a more complex compound, which may be, for example, a non-hydride as well as a hydride, to produce smaller or less complex constituents.

Another goal of the present disclosure is to provide apparatuses and methods of decomposing a compound into lower-weight or simpler constituent substances by applying resonant EM waves for various uses.

Another goal of the present disclosure is to provide apparatuses and methods of breaking a chemical bond within and/or between molecules of a compound by using sunlight or solar EM waves.

Another goal of the present disclosure is to provide apparatuses and methods of splitting a compound in natural resources such as, for example, methane, petroleum, or water, which may be eco-friendlier and more cost-effective than other conventional processes.

Another goal of the present disclosure is to provide apparatuses and methods of decomposing a compound in natural resources such as, for example, methane, profane, petroleum, or water in multiple sizes for diverse applications.

Objects of the present disclosure are not limited to those mentioned above, and other goals not mentioned will be clearly understood by those skilled in the art from the following description.

An apparatus and a method for decomposing a compound, according to one exemplary embodiment of the present disclosure for achieving the above goals, may include, for example, an enclosure, container, or tank for storing source material or a compound such as methane, ethane, profane, butane, petroleum, naphtha, water, etc., therein, a wave generator for generating at least one electromagnetic (EM) wave having at least one frequency applied to the compound stored in the enclosure in at least one direction, and a control unit for determining the frequency of the EM wave generated by the wave generator.

According to an embodiment of the present disclosure, the control unit may control the wave generator so that the at least one EM wave has a frequency that corresponds to at least one of the natural vibration of a chemical bond of the compound stored in the enclosure, an integer multiple of the natural vibration, and an integer submultiple of the natural vibration or a frequency obtained by dividing the natural vibration by an integer.

According to an embodiment of the present disclosure, the control unit may control the wave generator so that the at least one EM wave has a frequency that corresponds to at least one of an intermediate value between the natural vibration of a first chemical bond of the compound and the natural vibration of a second chemical bond of the compound stored within the enclosure, multiples of the intermediate value, and submultiples of the intermediate value.

A chemical bond as used herein constitutes a compound by continuous mutual attraction between atoms, ions, or molecules, and acts between the constituent atoms, ions, and molecules in an aggregate of atoms or groups of atoms, and means a force or bond that allows them to be regarded as a unit. The chemical bond may include, for example, at least one of a covalent bond, a hydrogen bond, an ionic bond, a metal bond, a coordinate bond, etc.

According to another embodiment of the present disclosure, the apparatus and the method may further include a cathode including at least one negative electrode electrically connected and configured to be controlled by the control unit; and an anode including at least one positive electrode is electrically connected and configured to be controlled by the control unit.

According to another embodiment of the present disclosure, the control unit may apply a voltage equal to or greater than a reference value between the cathode and the anode so that electrochemical reactions and attractions occur in the compound or source material stored in the enclosure.

According to another embodiment of the present disclosure for achieving the above goals, the compound may be a hydride or a non-hydride, and the EM wave may decompose the compound into hydrogen gas and by-products, or constituent substances of less complex or smaller units.

According to an embodiment of the present disclosure, the wave generator may apply an EM wave to the compound in a direction parallel to at least one of the cathode and the anode.

According to an embodiment of the present disclosure, the apparatus and the method may further include at least one membrane or separator positioned between at least one pair of the at least one negative electrode and at least one positive electrode.

According to an embodiment of the present disclosure, at least one EM wave may be configured to be applied to the compound stored in the enclosure in a direction parallel to at least one of the cathode and the anode.

According to an embodiment of the present disclosure, at least one of the cathode and the anode may have at least one hole, and the EM wave generated by the wave generator may pass through the at least one hole.

According to an embodiment of the present disclosure, the apparatus may have at least one housing external to at least one of the cathode and the anode in order to separately collect at least one decomposed constituent produced at the cathode and/or the anode.

According to an embodiment of the present disclosure, the apparatus may further comprise at least one pipe positioned within the enclosure, where the pipe may include at least one injection nozzle configured to spray the compound in the form of mist or small droplets in the enclosure.

According to an embodiment of the present disclosure, the compound may be a hydride or a non-hydride and the EM wave may decompose the compound into hydrogen gas and its by-products, or into constituent substances that are less complex or smaller units than the compound.

According to another embodiment of the present disclosure, the apparatus may further comprise a magnet disposed adjacent to the compound stored in the enclosure.

According to an embodiment of the present disclosure, the apparatus may further include an EM wave collector or a wave collector that collects solar waves or external EM waves and a support that supports the wave collector so that the collected solar waves or external EM waves may be applied to the compound stored in the enclosure. Further, the wave collector may include a lens and/or a mirror, and the compound may be decomposed by one of the solar waves, the external EM waves, and the EM waves generated by the wave generator.

According to an embodiment of the present disclosure, the apparatus may further include at least one wave pipe that transmits the collected solar waves or the collected external EM waves guided and irradiated to the compound in the enclosure.

According to an embodiment of the present disclosure, the wave pipe may comprise at least one of waveguide, optical fiber, optical cable, and prism.

According to an embodiment of the present disclosure, the apparatus and the method may be used in conjunction with at least one of conventional production methods such as steam reforming, pyrolysis, electrolysis, etc. in order to achieve higher production rate or efficiency.

According to an embodiment of the present disclosure, the apparatus may produce lower-weight or less-complex constituents from a non-hydride or a hydride such as methane, profane, petroleum, naphtha, ethane, water, etc.

According to an embodiment of the present disclosure, the apparatus may be implemented in various sizes and shapes according to the applications.

According to an embodiment of the present disclosure, the wave generator and an EM wave collecting controller may be configured to collect, concentrate, and apply solar EM waves or external EM waves comprising a spectral range of frequencies capable of resonating a chemical bond in the compound or source material to break into hydrogen.

According to another embodiment of the present disclosure for achieving the above goals, the control unit may control the wave generator to collect and condense external EM waves such as solar EM waves, and the control unit may further guide the external EM waves collected and concentrated by the wave generator to the compound or source material stored in the enclosure.

According to an embodiment of the present disclosure, the EM wave collecting controller and the control unit may be formed in the same configuration.

According to an embodiment of the present disclosure, the compound in which an electrolyte is dissolved may be stored in the enclosure.

According to an embodiment of the present disclosure, the compound stored in the enclosure may be a hydride or a non-hydride, and may be decomposed by the EM wave generated or collected by the wave generator.

According to an embodiment of the present disclosure, the cathode and the anode may be configured to be immersed in the compound within the enclosure.

Effects of the present disclosure are not limited to the effects mentioned above, and other effects not mentioned will be clearly understood by those skilled in the art from the description of the claims.

### BRIEF DESCRIPTION OF THE DRAWINGS

FIG. 1 is a functional block diagram illustrating a compound decomposing apparatus to produce hydrogen gas and its byproducts, or less complex constituent substances according to an embodiment of the present disclosure.

FIG. 2 is an illustration of a procedure for decomposing compound molecules into their constituents according to an embodiment of the present disclosure.

FIG. 3 is an illustration of an electrode arrangement of an apparatus according to an embodiment of the present disclosure.

FIG. 4 is an illustration of an electrode arrangement of an apparatus according to another embodiment of the present disclosure.

FIG. 5 is a view for explaining a method of producing hydrogen and other valuable by-products or relevant constituents using both a resonant EM wave and a magnetic field according to an embodiment of the present disclosure.

FIG. 6 is a view for explaining a method of producing hydrogen and other valuable by-products or related constituents using both a resonant EM wave and electrolysis according to another embodiment of the present disclosure.

FIG. 7 is a view for producing lower-weight constituents from a hydride or a non-hydride by using both a resonant EM wave and electrolysis, and further using a separation membrane according to an embodiment of the present disclosure.

FIG. 8 is an illustration of an electrode arrangement of an apparatus for producing hydrogen and other valuable lower-weight by-products from hydrogen compounds according to another embodiment of the present disclosure.

FIG. 9 is an illustration of the shape of the cathode and the anode according to another embodiment of the present disclosure.

FIG. 10 is a view for explaining a method of collecting hydrogen and other by-products generated at the cathode and the anode according to an embodiment of the present disclosure.

FIG. 11 is a view for explaining a method of increasing the production efficiency of hydrogen or other products by spraying a source material or compound in the form of mist according to another embodiment of the present disclosure.

FIG. 12 is a view for explaining an injection nozzle according to an embodiment of the present disclosure.

FIG. 13 is an illustration of electromagnetic (EM) spectrum, the entire distribution of EM radiation, according to frequency or wavelength according to an embodiment of the present disclosure.

FIG. 14 is an illustration of an EM wave collecting structure according to an embodiment of the present disclosure.

FIG. 15 is a view for illustrating the structure of an EM wave collector as an example according to an embodiment of the present disclosure.

### DETAILED DESCRIPTION

Hereinafter, embodiments of the present disclosure will be described in detail with reference to the accompanying drawings. However, the accompanying drawings are only described in order to more easily disclose the contents of the present disclosure, the embodiments are merely described below, by referring to the figures, to explain aspects of the present description, and the scope of the present disclosure is not limited to the scope of the accompanying drawings.

Further, in describing the embodiment of the present disclosure, the same name and the same reference numeral are used for the components having the same function, but substantially not completely the same as the components of the prior art.

In addition, the terms used in the present disclosure are only used to describe specific embodiments, and are not intended to limit the present disclosure. The singular expression includes the meaning of the plural unless the context clearly dictates otherwise. In the present disclosure, terms such as “comprise”, “include”, or “have” are intended to designate that a feature, number, step, operation, component, part, or a combination thereof described in the specification exists, and one or more other features, for example, the cathodes (110-1, 110-2, 110-3, 110-4, . . . , 110-i) and the anodes (130-1, 130-2, 130-3, 130-4, . . . , 130-j), or numbers, steps, operations, components, parts, or the presence or the additional possibility of a combination are to be understood as not being precluded in advance.

In the present disclosure, an electromagnetic (EM) wave means a wave that vibrates periodically, and refers to a frequency domain resonating with a chemical bond in a compound to decompose.

Hereinafter, a molecule-splitting apparatus according to an exemplary embodiment of the present disclosure will be described with reference to the accompanying drawings.

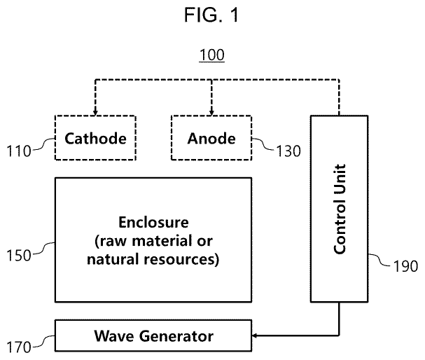

FIG. 1 is a functional block diagram for explaining a compound decomposing apparatus 100 for producing hydrogen and other by-products, or less complex constituent substances according to an embodiment of the present disclosure.

The compound decomposing apparatus 100 according to an embodiment of the present disclosure includes an enclosure 150, a wave generator 170, and a control unit 190 as exemplary components to decompose a compound into hydrogen and its by-products, or less-complex constituent substances. A cathode 110 and an anode 130 may be further included as exemplary components to effectively convert, separate, and collect the constituent substances. FIG. 1 only shows components related to the embodiment of the present disclosure, and of course, other components may be further included in addition to the components shown in FIG. 1 in implementing the present disclosure.

The cathode 110 is composed of at least one negative electrode, and the anode 130 is composed of at least one positive electrode. The cathode 110 and the anode 130 according to an embodiment of the present disclosure may be made of a metallic material.

Hydrogen ions, which are positive ions, are attached to the surface of the cathode 110 by electrical attraction. The hydrogen ions are absorbed to the cathode 110 as hydrogen atoms while obtaining electrons from the cathode 110 (Volmer reaction). Then, a reaction between one hydrogen atom adsorbed on the surface of the cathode 110 and a hydrogen ion present in the compound or source material such as, for example, water within the enclosure 150 (Heyrovsky reaction), or the bonding of two adsorbed hydrogen atoms (Tafel reaction) produces hydrogen gas.

The apparatus 100 for generating hydrogen gas and its by-products, or decomposing a compound according to an embodiment of the present disclosure may further include a device for collecting constituent substances produced at the cathode 110.

Other gaseous ions such as oxygen ions, which are negative ions, are attached to the surface of the anode 130 by electrical attraction. At the anode 130, in contrast to the cathode 110, an oxidation reaction occurs in which other gaseous ions donate electrons to become the corresponding gas. Similarly, the anode 130 may be further equipped with a device for collecting the produced the corresponding gas therein.

A configuration for collecting the hydrogen gas generated at the cathode 110 and the other gas generated at the anode 130 will be described in detail below.

The enclosure or tank 150 may store natural resources or source materials such as, for example, methane, profane, petroleum, naphtha, water, etc. in which electrolyte is dissolved according to a method of producing hydrogen and other gases.

The wave generator 170 generates at least one EM wave having at least one frequency (e.g., a predetermined frequency). The EM wave is applied to the compound or source material stored inside the enclosure 150 in one or more directions.

The wave generator 170 induces resonance of the molecules of the compound by applying EM waves to the compound within the enclosure 150. Specifically, when an EM wave is applied to the inside of the enclosure 150 and collides with the molecules therein, the wave energy of the EM wave is absorbed by the molecules. When the compound is water, it is probabilistic that molecules on the surface of the water can have fewer hydrogen bonds than other molecules inside the water. Therefore, the application of EM waves to the surface and subsurface of a compound may be more effective in producing constituent substances such as hydrogen and oxygen.

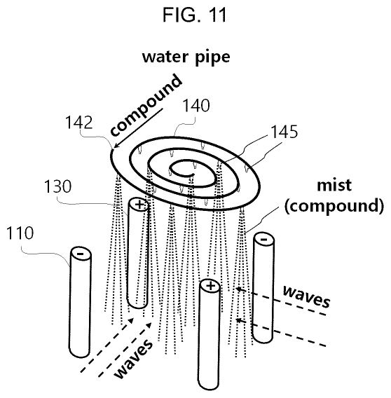

A way of effectively increasing the surface area of a compound or a source material exposed to a resonant EM wave in the form of droplets or mist will be described in detail with reference to FIG. 11.

Molecules of the compound that absorb the energy of an EM wave experience vibration. Furthermore, when the frequency of the EM wave absorbed by the molecules matches the natural vibration or frequency of the molecules, resonance occurs. Here, the natural or fundamental frequency is a concept encompassing both the natural frequency, oscillation, fluctuation, or vibration of an electrochemical bond between molecules of a compound to decompose and the natural frequency, oscillation, fluctuation, or vibration of an electrochemical bond between elementary atoms inside the molecules.

When resonance occurs, the amplitude of the vibration increases rapidly, reaching an energy level sufficient to break the electrochemical bonds of the compound. Eventually, intramolecular bonds and intermolecular bonds of the compound stored in the enclosure 150 are broken and the molecules are decomposed into positively charged ions (e.g., hydrogen ions) and negatively charged ions (e.g., oxygen ions), respectively.

The control unit 190 may control the overall operations of the compound decomposing apparatus 100. For example, the control unit 190 determines a frequency of the EM wave generated by the wave generator 170, and a predetermined voltage applied so that the cathode 110 and the anode 130 have relative electric potential levels, respectively.

A detailed control operation of the control unit 190 is described as follows.

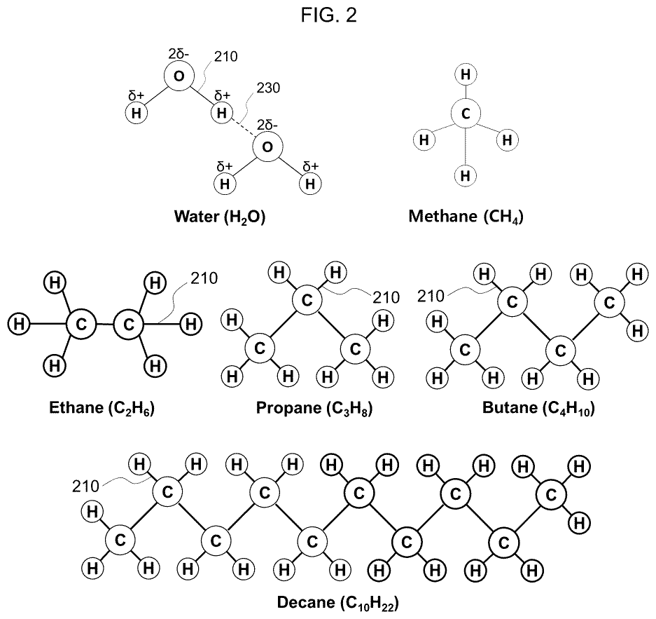

FIG. 2 is a view for explaining a procedure for decomposing a compound into ions of constituent substances according to an embodiment of the present disclosure.

Molecules include two or more atoms chemically joined together whereas compounds have two or more heterogeneous elements chemically joined together. That is, molecules may be either heteronuclear or homonuclear while compounds are made up of different elements. Both molecules and compounds are jointed with chemical bonds.

There are two major types of chemical bonds in a compound: intramolecular and intermolecular bonds. In modern electrochemistry, for example, in water the intramolecular bond is known as the covalent (i.e., the O—H bond) while the intermolecular bond is the hydrogen bond (i.e., the H—OH bond). All molecules have at least one type of chemical bonds within the molecules and among the molecules.

Bond energy is defined as the amount of energy required to break apart a mole of molecules into its component atoms. It is a measure of the strength of a chemical bond. Bond energy is also known as bond enthalpy (H) or simply as bond strength. Bond energy is an average of bond-dissociation values for all bonds of the same type within the same chemical species in the gas phase, typically at a temperature of 298.15 Kelvin. Breaking subsequent bonds requires a different amount of energy. It may be found by measuring or calculating the enthalpy change of breaking a molecule into its component atoms and ions and dividing the value by the number of chemical bonds. The bond-dissociation energy (enthalpy) is also referred to as bond disruption energy, bond energy, bond strength, or binding energy (abbreviation: BDE, BE, or D).

Bond energies usually depend on the compounds in source materials. For example, in water the O—H bond energy is 428 kJ/mol in average whereas the H—OH bond energy is 498.7 kJ/mol, where the bond energy is the amount of energy to dissociate its corresponding bond in average, and mol is the symbol of the mole which is the unit of measurement for amount of substance, defined as about 6.02×10²³ particles. The natural or fundamental frequencies of the EM waves associated with these bonding energies in the water compounds are about 1.07 PHz and 1.25 PHz, respectively. Compounds contained in other source materials such as, for example, methane, profane, petroleum, naphtha, etc. have unique fundamental frequencies associated with their intramolecular and/or intermolecular bonding energies.

Note that besides the source materials themselves, the bond energy and thus fundamental frequency may also vary with the environmental conditions such as, for example, ambient pressure and temperature. The detailed values of the bonding energies of the compounds of various key source materials such as, for example, methane and water are already well known. The natural or fundamental frequencies of the compounds or source materials of interest in the present disclosure are values that typically change near about 1 PHz at normal pressure and room temperature, but not fixed.

In the embodiment of FIG. 2, a water molecule includes a covalent bond 210 formed by each of a hydrogen atom and an oxygen atom donating an electron to make an electron pair and sharing the pair together.

On the other hand, in the covalent bond 210 between oxygen and hydrogen within the water molecule, due to the difference in electronegativity between oxygen and hydrogen, the atomic nucleus of oxygen attracts an electron pair stronger than the atomic nucleus of hydrogen, so that the shared electron pair is closer to and more likely to stay on the oxygen atom compared to the hydrogen atom.

For the reasons mentioned above, the oxygen atom of the water molecule is partially negatively charged (2δ−) and each hydrogen atom is partially positively charged (δ+). Due to the difference in polarity, hydrogen bonds 230 among water molecules are formed.

Therefore, in order to decompose water molecules to obtain hydrogen ions and oxygen ions, not only the covalent bond 210 inside the water molecule but also the hydrogen bond 230 among the water molecules must be broken.

As discussed above, the bond dissociation energy for breaking the covalent bond 210 inside the water molecule is 428 kJ/mol, and the bond dissociation energy for breaking the hydrogen bond 230 between the water molecules is 498.7 kJ/mol, and both bonds require very high energy for dissociation.

On the other hand, the natural frequency of the covalent bond 210 is 1.07 PHz, and the natural frequency of the hydrogen bond 230 is 1.25 PHz. Therefore, when an EM wave having a frequency of 1.07 PHz is applied from the outside, resonance occurs in the covalent bond 210, so that the covalent bond 210 is broken even if an energy corresponding to the above-described bond dissociation energy is not applied in another way. Similarly, when an EM wave having a frequency of about 1.25 PHz is applied from the outside, resonance may occur in the hydrogen bond 230, so that even if an energy corresponding to the bond dissociation energy of the hydrogen bond 230 is not applied in another way, the hydrogen bond 230 may be cut off.

However, EM waves having these two frequencies are not necessarily required to separate water molecules into oxygen and hydrogen. Resonance may occur even when an EM wave of a frequency adjacent to the natural frequency or a frequency between the natural frequency of the covalent bond 210 and the natural frequency of the hydrogen bond 230 is applied. For example, when an EM wave having about 1.16 PHz applied, resonance may occur in both the intramolecular covalent bond 210 and the intermolecular hydrogen bond 230.

Accordingly, the wave generator 170, according to an embodiment of the present disclosure, generates at least one EM wave associated with the natural frequency that corresponds to the natural vibration of the covalent bond 210 in the water within the enclosure 150.

The wave generator 170, according to another embodiment of the present disclosure, generates at least one EM wave associated with the natural frequency that corresponds to the natural vibration of the hydrogen bond 230 in the water within the enclosure 150.

The wave generator 170, according to another embodiment of the present disclosure, generates at least one EM wave associated with a frequency that corresponds to an intermediate value between the natural vibration of the covalent bond 210 and the natural vibration of the hydrogen bond 230 in the water within the enclosure 150.

Alternatively, the control unit 190, according to an embodiment of the present disclosure, may control the wave generator 170 to generate at least one EM wave having at least one of a frequency corresponding to the natural vibration of the covalent bond 210, a frequency corresponding to the natural vibration of the hydrogen bond 230, and a frequency corresponding to an intermediate value between the natural vibration of the covalent bond 210 and the natural vibration of the hydrogen bond 230 in the water within the enclosure 150.

To this end, the wave generator 170, according to an embodiment of the present disclosure, may be implemented as at least one of several types of wave generators such as a function generator, a radio frequency and microwave signal generator, a pitch generator, an arbitrary waveform generator, a digital pattern generator, a frequency generator, etc.

Meanwhile, resonance does not occur only when an EM wave having the same frequency as the natural vibration of the covalent bond 210 or the hydrogen bond 230 is applied. For example, resonance may be induced to occur when harmonic waves or harmonics (e.g., integer multiples of a frequency corresponding to the natural vibration of a system) are applied. Also, resonance may be induced to occur when some subharmonic waves or subharmonics (e.g., fractional frequency components or integer submultiples of a frequency corresponding to the natural vibration of a system) are applied.

Therefore, the control unit 190, according to another embodiment of the present disclosure, controls the wave generator 170 to generate at least one EM wave having at least one multiple of the natural frequency of the covalent bond 210, or at least one submultiple of the natural frequency of the covalent bond 210 in the water within the enclosure 150.

The control unit 190, according to another embodiment of the present disclosure, controls the wave generator 170 to generate at least one EM wave having at least one multiple of the natural frequency of the hydrogen bond 230, or at least one submultiple of the natural frequency of the hydrogen bond 230 in the water within the enclosure 150.

The control unit 190, according to another embodiment of the present disclosure, controls the wave generator 170 to generate at least one EM wave having at least one multiple of an intermediate value between the natural frequency of the covalent bond 210 and the natural frequency of the hydrogen bond 230, or at least one submultiple of an intermediate value between the natural frequency of the covalent bond 210 and the natural frequency of the hydrogen bond 230 in the water within the enclosure 150.

According to the method described above, it is possible to obtain the effect of inducing resonance of water molecules without generating an EM wave having an excessively high frequency.

Meanwhile, the oxygen-hydrogen bond energy inside a water molecule, the bond energy between the water molecules, and their average bond energy may vary depending on ambient conditions or the density of the electrolyte dissolved in water. Accordingly, the control unit 190, according to an embodiment of the present disclosure, may perform at least one of frequency division, frequency mixing, frequency multiplication, and frequency sweeping to select an optimal frequency capable of resonating water molecules within a predetermined frequency range.

FIG. 2 also illustrates an exemplary embodiment of the enthalpy change of breaking methane (CH₄) into a carbon atom and four hydrogen ions, divided by four (the number of C—H) bonds, yields the bond energy. Note that the bonds vary on various aspects such as bond length, bond angle, bond strength, nature of molecule, solid type (crystalline or amorphous), etc. Covalent bonds are formed by sharing two or more electrons. The number of shared electrons between elements, or atoms, determines the number of bonds. A pair of two shared electrons accounts for one bond. If one pair of two electrons are shared, the bond will be a single bond whereas if two atoms bonded by two pairs (four electrons), it will form a double bond. A triple bond is made by sharing three pairs (six atoms) of electrons. The sharing electrons are generally known as valence electrons. Single, double and triple bonds are all covalent bonds. For removing successive hydrogen atoms from methane the bond-dissociation energies are 105 kcal/mol (439 kJ/mol) for D(CH₃—H), 110 kcal/mol (460 kJ/mol) for D(CH₂—H), 101 kcal/mol (423 kJ/mol) for D(CH—H) and finally 81 kcal/mol (339 kJ/mol) for D(C—H), where D means the bond-dissociation energy. The bond energy is, thus, 99 kcal/mol or 414 kJ/mol (the average of the bond-dissociation energies). None of the individual bond-dissociation energies equals the bond energy of 99 kcal/mol.

In the exemplary embodiment of FIG. 2, the natural frequencies corresponding to the bond-dissociation energies of the four covalent bonds in methane are 1.10 PHz, 1.153 PHz, 1.06, and 0.85 PHz, respectively. The natural frequency of the bond energy in methane is 1.04 PHz. Therefore, when an EM wave having a frequency of 1.10 PHz is applied from the outside, resonance occurs in the CH₃—H covalent bond 210, so that the CH₃—H covalent bond 210 is broken even if an energy corresponding to the above-described bond dissociation energy is not applied in another way.

Similarly, when an EM wave having a frequency of 1.153 PHz is applied from the outside, resonance occurs in the CH₂—H covalent bond 210, so that the CH₂—H covalent bond 210 is broken even if an energy corresponding to the above-described bond dissociation energy is not applied in another way, and so on.

Furthermore, in FIG. 2, resonance may start to occur even when an EM wave of a frequency adjacent to the natural frequency of a system. The natural frequencies of the four covalent bonds in methane are near their average value, i.e., the natural frequency of methane, which is 1.04 PHz. That is, when an EM wave of about 1.04 PHz is applied to methane inside the enclosure 150, resonance may occur in the intramolecular covalent bonds 210 although its efficiency is lower than when the natural frequencies corresponding to the four covalent bonds in methane are used together.

As mentioned in FIG. 2, according to an embodiment of the present disclosure, the components shown in FIG. 1 and other additional components (not shown in FIG. 1) may be set to work accordingly. For example, the wave generator 170 generates at least one EM wave associated with the natural frequencies that correspond to the natural vibration of the covalent bond 210 in methane within the enclosure 150, and the control unit 190 determines a frequency of the EM wave generated by the wave generator 170, and a predetermined voltage applied so that the cathode 110 and the anode 130 each have their electrical polarity, etc.

FIG. 2 also shows several compounds contained in petroleum stored in the enclosure 150. Petroleum is mainly a mixture of hydrocarbons, i.e. containing only carbon and hydrogen. The most common compounds in petroleum, also known as crude oil, or simply oil, are alkanes (paraffins), cycloalkanes (naphthenes), and aromatic hydrocarbons. They generally have from 5 to 40 carbon atoms per molecule, although trace amounts of shorter or longer molecules may be present in the mixture. The composition of petroleum remains basically the same (C, H, and O, with small amounts of S and N), but heat and pressure cause more and more chemical bonds to form between the atoms

In the embodiment of FIG. 2, the enthalpy changes of breaking petroleum molecules into carbon atoms and hydrogen ions, divided by multiple (the number of C—H) chemical bonds, yield the bond energy.

FIG. 2 exemplifies possible embodiments of the present disclosure for producing hydrogen and other by-products. Effects of the present disclosure are not limited to the effects mentioned in FIG. 2, and other effects not mentioned will be clearly understood by those skilled in the art from the description of the claims.

According to another exemplary embodiment, the present disclosure may be implemented in conjunction with conventional oil-refining methods as well as Steam reforming, Pyrolysis, etc. to more effectively produce hydrogen and other by-products from hydrides such as petroleum, methane, ethane, propane, butane, etc. that contain hydrogen in their compounds or molecules.

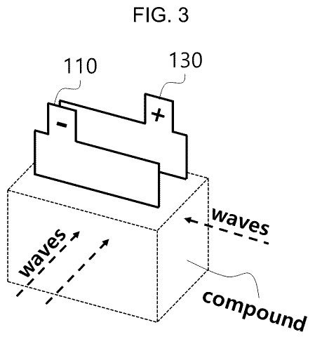

FIG. 3 is a view for explaining an electrode arrangement of the apparatus 100 for producing hydrogen and other by-products, or decomposing a compound according to an embodiment of the present disclosure.

The cathode 110 and the anode 130 according to an embodiment of the present disclosure may be disposed to contact the surface of the source materials or to be partially immersed in the source materials within the enclosure 150.

At this time, the wave generator 170 may be deployed to apply an EM wave to the source materials inside the enclosure 150 in any direction. Alternatively, the wave generator 170 may be deployed to apply at least one EM wave to the source materials inside the enclosure 150 in at least one direction.

When an EM wave incident from the wave generator 170 reaches the molecules or atoms of source materials, the wave energy of the EM wave is absorbed by the molecules. The absorbed wave energy causes resonance, breaking not only the intermolecular bonds between the molecules but also the intramolecular bonds inside the source-material molecules if any.

For example, if source material is water, when the covalent bond 210 and the hydrogen bond 230 of the water molecule are broken, a hydrogen ion that is a cation and an oxygen ion that is an anion are generated. The cathode 110 and the anode 130 have different electric potentials to each other. Due to an electrical force or an electric field developed between the electrodes of the cathode 110 and the anode 130, the hydrogen ions and the oxygen ions become attracted to the cathode 110 and the anode 130, respectively, and converted thereto into hydrogen gas and oxygen gas, respectively.

A process in which the cathode 110 and the anode 130 supply negative and positive charges to hydrogen ions and oxygen ions, respectively, and a process in which the hydrogen and oxygen ions are converted into their gaseous states have been described in detail with reference to FIG. 1, so here a duplicate description is omitted.

Meanwhile, the arrangement of the cathode 110 and the anode 130 is not limited to that shown in FIG. 3 and may be arranged in various ways or shapes.

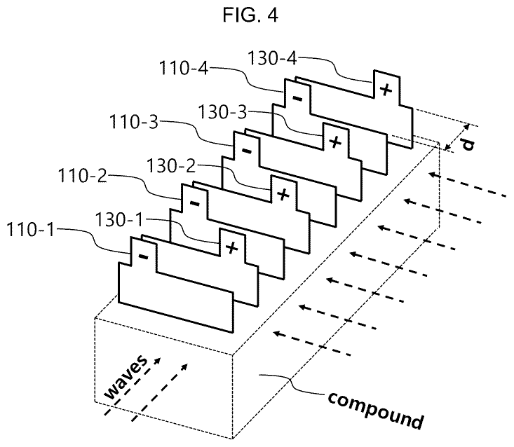

FIG. 4 is a view for explaining an electrode arrangement of the apparatus 100 for producing hydrogen and oxygen, or decomposing a compound according to another embodiment of the present disclosure.

According to another embodiment of the present disclosure, a plurality of cathodes 110-1, 110-2, 110-3, 110-4, . . . , 110-i and a plurality of anodes 130-1, 130-2, 130-3, 130-4, . . . , 130-j may be alternately arranged in a form facing each other.

As shown in FIG. 3, a plurality of cathodes and a plurality of anodes may be arranged to contact the surface of the source materials or to be partially immersed in the source materials within the enclosure 150.

In FIG. 4, a plurality of cathodes 110-1, 110-2, 110-3, 110-4, . . . , 110-i and a plurality of anodes 130-1, 130-2, 130-3, 130-4, . . . , 130-j are arranged to produce more hydrogen and other by-products generated by the dissociation of source material.

At the cathodes 110, hydrogen ions are reduced to generate hydrogen gas, and at the anodes 130, other ions are oxidized to generate their gas. The more pairs of cathode and anode electrodes, the more hydrogen gas and by-product gas generated.

Accordingly, the number of the cathode electrodes and the anode electrodes may be appropriately adjusted according to the use and purpose of the compound decomposing apparatus 100.

The arrangement of the cathodes 110 and the anodes 130 is not limited to that shown in FIG. 4 and may be disposed in various shapes or ways.

Meanwhile, in the above example, production of hydrogen gas and other valuable by-products (e.g., oxygen gas) from hydrogen compounds (or hydrides) as source materials using resonant EM waves has been described as an example, but at least one of magnetic field induction and electrolysis may be performed in conjunction with resonant EM waves for higher efficiency of hydrogen and other by-product production.

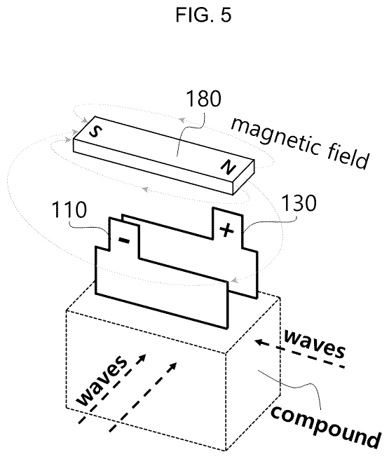

FIG. 5 is a view for explaining a method of generating hydrogen and other lower-weight by-products from hydrogen compounds using both a resonant EM wave and a magnetic field according to an embodiment of the present disclosure.

The compound decomposing apparatus 100, according to an embodiment of the present disclosure, may further include a magnet 180 disposed adjacent to the source materials within the enclosure 150.

Just as electrons spin, so do some nuclei (e.g., protons). The nucleus actually rotates round that axis of the nuclear spin (known as precession), which causes the atomic nucleus to have small magnetic properties.

In the absence of an external magnetic field, the nuclear spin, or more precisely, the precession axis of the nuclear spin, is randomly aligned. When a magnetic field is applied from the outside, an induced magnetic field is generated, in which the nuclear spins are aligned in the same or opposite direction to the external magnetic field.

The nucleus of a hydrogen atom in source material may spin in an arbitrary direction. Therefore, when placed in a strong magnetic field, the spin direction of the nuclei of hydrogen atom is aligned along the direction of the magnetic field, which causes hydrogen-containing molecules to align with the direction of the externally applied magnetic field (even if some molecules may align in the opposite direction of the external magnetic field). If EM waves are applied in the vertical direction in this state, the molecules will be able to more effectively absorb the energy of the applied EM waves.

In particular, since the molecules on the surface of source material are limited by one-dimension in terms of the spatial freedom of movement, the direction in which an EM wave is applied may be determined so that the energy of the EM wave may be absorbed more effectively.

Permanent magnets, such as neodymium magnets, create a magnetic field around them. And, the electromagnets induce a magnetic field while current flows in the conducting wire. In order to generate a magnetic field applied from the outside, an electromagnet or a permanent magnet may be used.

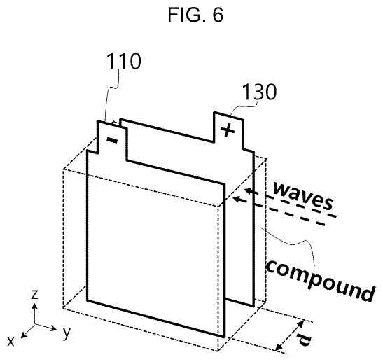

FIG. 6 is an illustration for explaining a method of generating hydrogen and its by-byproducts using both resonant EM waves and electrolysis according to an embodiment of the present disclosure.

In the apparatus 100 for producing hydrogen and other by-products, or decomposing a compound according to an embodiment of the present disclosure, EM waves having at least one frequency output from the wave generator 170 are applied to source material within the enclosure 150, and at the same time the cathode 110 and the anode 130 may allow electrolysis to proceed in source material within the enclosure 150.

For this purpose, since production of hydrogen and other by-products by electrolysis may occur on the surfaces of the cathode 110 and the anode 130, when electrolysis is performed together with resonant EM waves, the cathode 110 and the anode 130 may be configured to be submerged (e.g., deeply submerged) in the source material.

In addition, when pure water is used as a source material, an electrolyte may be dissolved in the water stored in the enclosure 150 since electricity may not flow well in pure water.

The control unit 190 is coupled to the cathode 110 and the anode 130, and may apply a voltage equal to or greater than a reference value between the negative and positive electrodes so that electrolysis occurs in source material within the enclosure 150. For example, when using pure water as a source material, the control unit 190, according to an embodiment of the present disclosure, may preferably determine a voltage so that the electric potential difference between the cathode 110 and the anode 130 is equal to or greater than the standard reduction potential of hydrogen of 1.23 V.

When the cathode 110 and the anode 130 are disposed to be immersed in source material stored in the enclosure 150, the wave generator 170 beams EM waves having at least one frequency (e.g., a predetermined frequency) at the source material in a direction parallel to the plate-shaped cathode 110 and anode 130 (for example, in the y-axis or z-axis direction of FIG. 6).

This is because when an EM wave generated by the wave generator 170 is applied to the source material inside the enclosure 150 in a direction perpendicular to the cathode 110 and the anode 130, the EM wave may be impeded by the plates made of metallic material and the absorption efficiency of the EM wave decreases.

For example, when an EM wave is applied in a direction along the x-axis direction shown in FIG. 6, the EM wave is reflected or shielded by a metallic plate-shaped cathode and/or anode to reach only a portion of source material within the enclosure 150.

Therefore, the wave generator 170 according to an embodiment of the present disclosure applies an EM wave to the source material within the enclosure 150 in a direction parallel to the plate-shaped cathode 110 and anode 130 (or along at least one of the z-axis and y-axis directions shown in FIG. 6).

As described above, hydrogen and other by-product generation by EM wave resonance combined with electrolysis may achieve the effect of further increasing the hydrogen and its by-product production rate and efficiency.

In addition, when hydrogen and other by-product generation by resonant EM waves is performed in conjunction with generation of hydrogen and other by-products by at least one of magnetic field induction and electrolysis, the cathode 110 and the anode 130 may, of course, be implemented in a form in which they are alternately and repeatedly disposed.

Meanwhile, as the electric potential difference between the cathode electrode and the anode electrode increases, the strength of an electric field generated between the two electrodes becomes stronger, thereby the generated hydrogen ions and other ions (e.g., oxygen ions) are strongly attracted to the electrodes, respectively and separately.

Alternatively, as the distance between the two electrodes (indicated by “d” in FIG. 6) becomes narrower, the strength of the electric field generated in between the two electrodes also becomes stronger, so that the generated hydrogen ions and other ions (e.g., oxygen ions) are pulled harder to the electrodes, respectively and separately.

In extreme cases, such as nanogap electrochemical cells, when the distance between the cathode electrode 110 and the anode electrode 130 becomes as narrow as the Debye length (e.g., 37 nanometers for water electrolysis), a very powerful and uniform electric field formed in between the two electrodes may lead to a reaction close to the breakdown of molecules and further enhance ion-migration in the bulk solution of source material, thereby increasing the overall reaction rate of the reactants.

This virtual breakdown of molecules is also affected by the surrounding environment, such as the electric potential difference between the two electrodes, the electrolyte concentration, temperature, pressure, etc. Therefore, the use of source material or the compound in which an electrolyte is dissolved may facilitate this reaction even with a less narrow gap between the two electrodes.

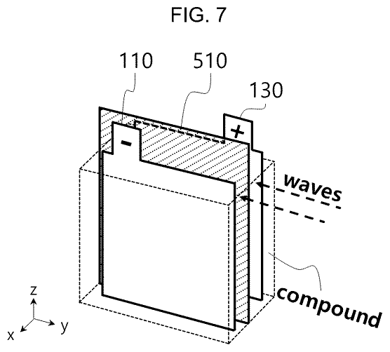

FIG. 7 is a view for explaining a method of producing hydrogen and other by-products using both resonant EM waves and electrolysis with a membrane according to another embodiment of the present disclosure.

As already shown in FIG. 6, the apparatus 100 for decomposing a compound shown in FIG. 7 as well may allow an EM wave having a predetermined frequency output from the wave generator 170 to be applied to source material, and at the same time to perform electrolysis in the source material within the enclosure 150.

To this end, the apparatus 100 according to an embodiment of the present disclosure may further include a membrane or separator 510 disposed between the cathode 110 and the anode 130.

The membrane 510 according to an embodiment of the present disclosure may be implemented as a polyelectrolyte membrane, a proton exchange membrane, etc. according to an electrolysis method, but is not limited thereto. Here, the membrane 510 prevents mixing of generated hydrogen and other by-product gases and electrically separates the cathode 110 from the anode 130.

Additionally, since the generation of hydrogen and other by-products by electrolysis is made on the surfaces of the cathode 110 and the anode 130, when electrolysis is performed together with the application of EM waves, the cathode 110 and the anode 130 are disposed in such a way that they are deeply immersed in the source material within the enclosure 150.

The control unit 190 may apply a voltage equal to or greater than a reference value between the negative and positive electrodes so that electrolysis occurs in source material within the enclosure 150.

For example, when using pure water as source material, the control unit 190, according to an embodiment of the present disclosure, may preferably determine a voltage so that the electric potential difference between the cathode 110 and the anode 130 is equal to or greater than the standard reduction potential of hydrogen of 1.23 V.

When the cathode 110 and the anode 130 are disposed to be immersed in source material, the wave generator 170 according to an embodiment of the present emits EM waves having at least one predetermined frequency to the source material within the enclosure 150 in a direction parallel to the plate-shaped cathode 110 and anode 130.

For example, when an EM wave is applied in a direction along the x-axis direction shown in FIG. 7, the EM wave is reflected or shielded by an electrode plate to reach only a portion of source material stored in the enclosure 150.

Therefore, the wave generator 170 according to an embodiment of the present disclosure applies an EM wave to the compound within the enclosure 150 in a direction parallel to the plate-shaped cathode 110 and anode 130 (or along the y-axis or y-axis direction shown in FIG. 7).

As described above, production of constituent substances by EM wave resonance combined with electrolysis may have the effect of further increasing the production rate and efficiency.

EM waves are typically described by any of the following three physical properties: the frequency f, wavelength A, or photon energy E. Wavelength is inversely proportional to the wave frequency, so gamma rays have very short wavelengths that are fractions of the size of atoms, whereas wavelengths on the opposite end of the spectrum can be indefinitely long. Photon energy is directly proportional to the wave frequency, so gamma ray photons have the highest energy (around billion electron volts), while radio wave photons have very low energy (around femto electron volts). These relations are illustrated by the following equations:

$$f = \frac{c}{λ} , or f = \frac{E}{h} , or E = \frac{h c}{λ} ,$$

where c is the speed of light (i.e., 299,792,458 m/s in a vacuum), and h is the Plank constant (i.e., 6.62607015×10⁻³⁴ J·s=4.13566733×10⁻¹⁵ eVs). For example, as shown in FIG. 2, a covalent (O—H) bond in water molecules has the bond energy of 428 kJ/mol (˜5.17 eV) per bond and the natural frequency of 1.07 PHz.

Sunlight or solar waves are EM radiation emitted by the sun's fusion reactions. Solar EM radiation includes a wide range of frequencies that may cover the natural frequency of a compound like water (e.g., about 1 PHz near the boundary between visible light and ultraviolet light), an integer multiple of that natural frequency (called harmonics), and an integer submultiple of that natural frequency (called subharmonics) or a frequency obtained by dividing that natural frequency by an integer.

In order to gather solar EM energy, conventional methods such as lenses, antennas, dishes, and telescopes, to more recent methods using phased-array antennas, etc. may be used. In focusing the gathered EM energy, according to an embodiment of the present disclosure, the wave generator 170 and the control unit 190 may additionally adopt mirrors that usually are a section of various shapes like a rotated parabola, a hyperbola, or ellipse, and optical cables that may transfer and expose the gathered and concentrated solar EM waves to the compound or source material stored in the enclosure 150.

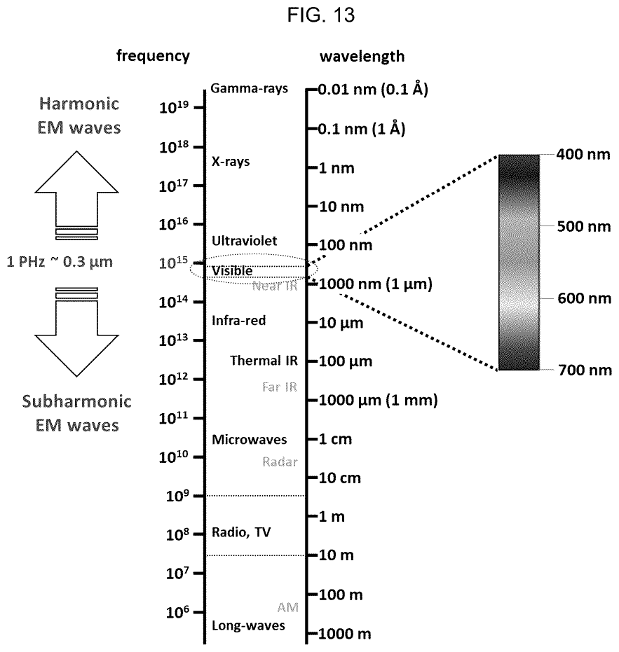

EM waves at and near the resonant frequency may vibrate and resonate a chemical bond at the atomic or molecular level. Resonance effectively accumulates the transferred EM energy and eventually break the chemical bond in a system. Most compounds containing hydrogen atoms have the natural frequencies of about 1 PHz, which corresponds to 0.3 um or 300 nm (FIG. 13).

FIG. 13 also shows that besides EM waves at and even near the natural frequency of each chemical bond of a compound, resonance may also occur with harmonic EM waves whose frequencies are about integer multiples of (and above) the natural frequency, and subharmonic EM waves whose frequencies are about integer submultiples of (and below) the natural frequency.

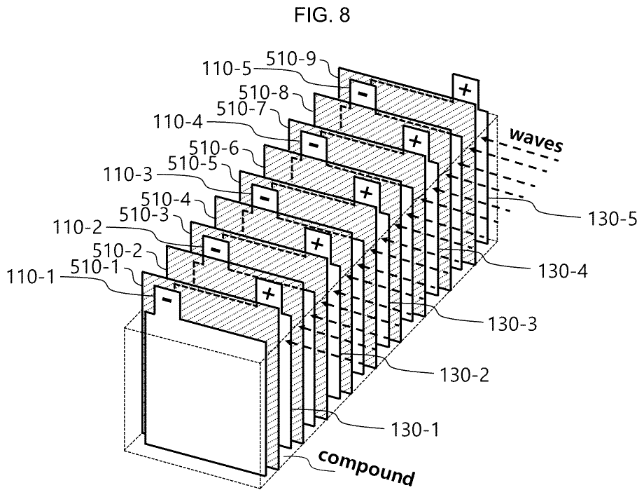

FIG. 8 is an illustration of an electrode arrangement of the compound decomposing apparatus 100 using both resonant EM waves and electrolysis with a membrane according to an embodiment of the present disclosure.

According to an embodiment of the present disclosure, a plurality of cathodes 110-1, 110-2, 110-3, 110-4, . . . , 110-i, a plurality of membranes 510-1, 510-2, 510-3, 510-4, . . . , 510-k, and a plurality of anodes 130-1, 130-2, 130-3, 130-4, . . . , 130-j may be repeatedly arranged in a successive order of cathode 110-membrane 510-anode 130-membrane 510.

As shown in FIG. 8, the use of a plurality of cathodes 110, anodes 130, and membranes 510 may achieve the effect of producing a larger amount of hydrogen and other by-products with both resonant EM waves and electrolysis.

Meanwhile, even in the embodiment shown in FIG. 8, the wave generator 170 applies EM waves to the source material within the enclosure 150 in a direction parallel to the plate-shaped cathode 110 and anode 130. In this case, at least one EM wave may be applied in at least one direction parallel to the plate-shaped cathode 110 and anode 130.

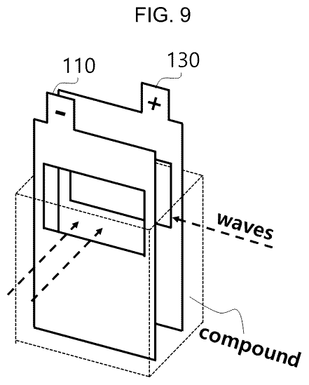

FIG. 9 is a view for explaining the shape of the cathode 110 and the anode 130 according to an embodiment of the present disclosure.

The cathode 110 and the anode 130, according to an embodiment of the present disclosure, are plate-shaped metal and include at least one hole. Here, the hole means an empty portion or part formed in the plate-shaped cathode 110 and anode 130.

As shown in FIG. 7 and FIG. 8, the plate-shaped cathode 110 and the plate-shaped anode 130 may shield or reflect EM waves incident in a certain direction (e.g., a direction perpendicular to the electrode plates), so that EM waves may only reach some region of the source material, and resonance of the molecules in the source material only occurs in other limited region of the source material within the enclosure 150.

For example, EM waves incident in a direction orthogonal to the plate-shaped cathode 110 and anode 130 are shielded by the cathode 110 and the anode 130 and the EM waves may not reach the molecules of the source material on the rear surfaces of the plate-shaped electrodes.

To this end, the cathode 110 and the anode 130 according to an embodiment of the present disclosure each include at least one hole. At this time, the wave generator 170 may generate EM waves orthogonal to the cathode 110 and the anode 130 passing through the holes and thus reaching the source material bulk within the enclosure 150.

However, the shape and number of the holes included in the cathode 110 and the anode 130 are not limited to those shown in FIG. 9, and multiple holes of various shapes may be formed in a plurality of areas.

Meanwhile, the cathode 110 and the anode 130 shown in FIG. 9 may be implemented in a form in which a plurality of negative electrodes and a plurality of positive electrodes are alternately and repeatedly disposed as shown in FIGS. 4 and 8.

In addition, when producing hydrogen and other by-products by both EM wave resonance and electrolysis with membranes, of course the electrodes and the membranes may be repeatedly arranged in a successive order of cathode 110-membrane 510-anode 130-membrane 510.

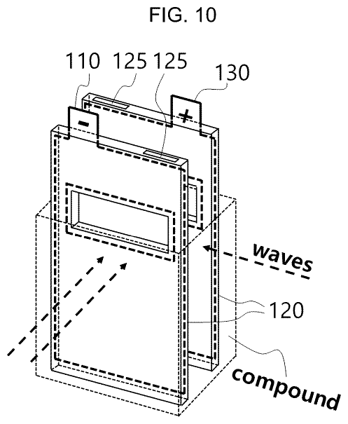

FIG. 10 is an illustration of a method for collecting hydrogen and other gases (e.g., oxygen) generated at the cathode and the anode, respectively, according to an embodiment of the present disclosure.

A housing 120 for collecting hydrogen gas generated at the cathode 110 is provided outside the cathode 110 according to an embodiment of the present disclosure. According to an embodiment of the present disclosure, hydrogen gas generated at the cathode 110 is collected inside the housing 120.

The hydrogen gas collected inside the housing 120 may be discharged to the outside through an opening 125 formed at the top of the housing 120, and then stored in a separate storage.

The anode 130 may also be equipped with a housing 120 on the outside of the anode 130 like the cathode 110, and the other gas (e.g., oxygen), if any, collected inside the housing 120 may be discharged to the outside through an opening 125 formed at the top of the housing 120, and then stored in another separate storage.

Meanwhile, when the housing 120 surrounds the cathode 110 or the anode 130, the electrode may not come into contact with the compound or source material stored in the enclosure 150, so the lower end of the housing 120 may be open.

FIG. 11 is a view for explaining a method for increasing the efficiency of producing hydrogen and other by-products by increasing the surface area of the source material molecules using a tube and an injection nozzle according to another embodiment of the present disclosure.

Probabilistically, the molecules existing on the surface of source material may have fewer bonds than the other molecules present inside the compound or source material (or the bulk), and may be more effectively dissociated by the wave energy of the applied EM waves.

Here, the wave generator 170 may be arranged to apply at least one EM wave to the compound inside the enclosure 150 in at least one direction.

To this end, according to an embodiment of the present disclosure, the apparatus 100 for producing hydrogen and other by-products, or decomposing a compound may further include a pipe 140 positioned (e.g., installed, etc.) inside the enclosure 150. The pipe 140 may have an inlet 142 and at least one injection nozzle 145. Source material is supplied to the pipe 140 through the inlet 142, and the injection nozzle 145 sprays the source material supplied from the outside into the enclosure 150 in the form of mist or droplets so that the droplets of source material in the mist form may be evenly distributed in the enclosure 150.

The cathode 110 and the anode 130 attract produced hydrogen ions and the other ions (if any and if required), and supply negative and positive charges to hydrogen ions and the other ions, and convert hydrogen ions and the other ions into their gaseous states, respectively. Since the process has been described in detail in FIG. 1, a redundant description is omitted.

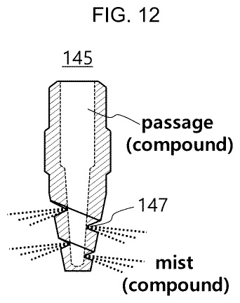

FIG. 12 is a view for explaining an injection nozzle according to an embodiment of the present disclosure. The injection nozzle 145 is composed of a conical inner compound or source-material passage, and the inner compound passage is connected to at least one nozzle hole 147. The nozzle hole 147 may inject the compound or source material supplied from the outside into the enclosure 150 in the form of mist or droplets having a uniform spray pattern in the shape of a spiral cone.

The injection nozzle 145 may provide an open passage ideal for use with source material that contains particulate matter, as is the case with the present disclosure.

Meanwhile, the arrangement of the pipe 140 is not limited to that shown in FIG. 11, and the number, location, and shape of the pipes may vary depending on the applications. Of course, at least one pipe 140 may be installed inside the enclosure 150, and disposed anywhere in the enclosure 150, including the side of the enclosure 150 with various shapes.

In addition, the structure of the injection nozzle 145 is not limited to that shown in FIG. 12, and may have various shapes, various numbers of the inner source-material passages, and at least one or more nozzle holes 147 at various positions along the inner source-material passage.

In the above, the case where the compound in the enclosure 150 is decomposed by the electromagnetic (EM) waves generated by the wave generator 170 has been described. Hereinafter, a case in which the compound in the enclosure 150 is decomposed by EM waves such as sunlight (or solar EM waves) will be described.

First, with reference to FIG. 13, a general description of the relationship between EM waves and compound decomposition will be described. FIG. 13 illustrates the EM spectrum, the frequencies of EM radiation such as sunlight, and their respective wavelengths. The behavior of EM radiation depends on its wavelength. When EM radiation interacts with individual atoms and molecules, its behavior also depends on the amount of energy per quantum (photon) it carries.

Sunlight or solar EM radiation is a sort of electromagnetic waves comprising a wide variety of frequency regions. Therefore, the compound decomposing apparatus 100 according to an embodiment of the present disclosure may decompose the source-material compound using not only an EM wave generated from the wave generator 170 but also sunlight (or solar EM wave) collected by the wave generator 170. For example, when a compound is water, visible light (VL) and ultraviolet (UV) of sunlight, X-rays, and gamma rays may be directly involved in separating hydrogen from oxygen in the compound. As another example, infrared rays and microwaves of sunlight may increase the temperature and thus thermal or kinetic or energy of the compound, thereby facilitating the decomposition of the compound too.

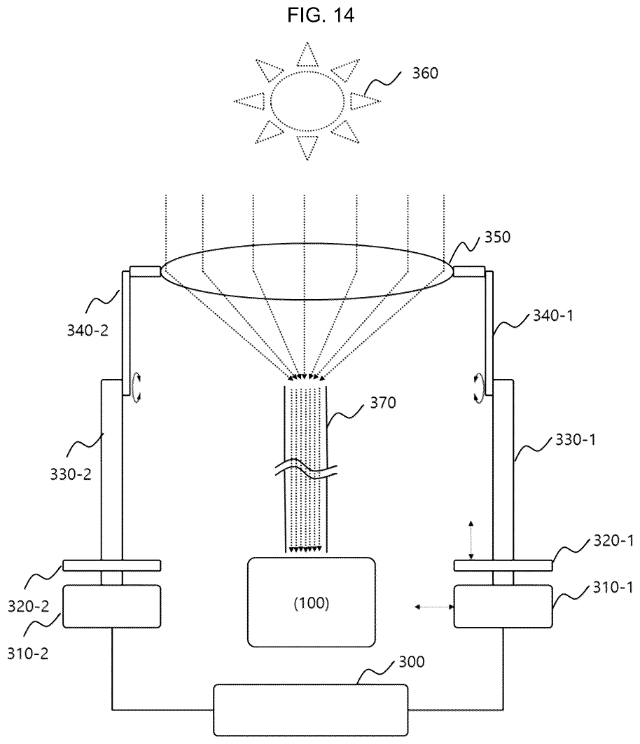

FIG. 14 is a view for explaining a light or EM wave collecting structure according to an embodiment of the present disclosure. The light or EM wave collecting structure is a configuration for intensively irradiating sunlight or EM waves to the source material or the compound contained in the enclosure 150 of the compound decomposition apparatus 100, and may include a light or EM wave collecting controller 300, a right pedestal 310-1, a left pedestal 310-2, a right length adjuster 320-1, a left length adjuster 320-2, a right support 330-1, a left support 330-2, a right rotator 340-1, a left rotator 340-2, an EM wave collector 350, and an EM wave pipe 370.

The EM wave collecting controller 300 may be configured to control the right and left length adjusters 320-1 and 320-2, and the right and left rotators 340-1 and 340-2. The wave collecting controller 300 may be configured to connect to a solar sensor (not shown) or a memory (not shown), and may adjust the right and left length adjusters 320-1 and 320-2, and the right and left rotators 340-1 and 340-2 by using information on an EM wave source or the sun 360 position sensed and reported from the solar sensor, or on the position of the EM source or the sun 360 stored in the memory.

The right and left pedestals 310-1 and 310-2 may be configured such that the light collecting structure may be stably supported on the ground or the like. The compound decomposing apparatus 100 according to an embodiment of the present disclosure, in particular the enclosure 150, may be located in the central portion of the right pedestal 310-1 and the left pedestal 310-2. The enclosure 150 may contain a source material or a compound to be decomposed. The enclosure 150 may be covered with a transparent material or open so that sunlight or the external EM wave collected and concentrated by the EM wave collecting structure may be applied or irradiated therein. In addition, the right and left pedestals 310-1 and 310-2 may be moved left and right by a control signal of the EM wave collecting controller 300. Accordingly, the right and left pedestals 310-1 and 310-2 may include at least one of a wheel, a motor, and the like.

The lower portion of the right length adjuster 320-1 may be configured to contact the upper portion of the right pedestal 310-1, and the upper portion may be configured to be connected to the right support 330-1. The right length adjuster 320-1 may be formed including a motor, a shaft, and a gear, and the motor may rotate according to a control signal from the wave collecting controller 300 to get the right length adjuster 320-1 closer to or away from the right pedestal 310-1. Accordingly, the position of the upper end of the right support 330-1 may be closer to or farther from the ground or the like. As a specific combination of forming the right length adjuster 320-1 through a motor, a shaft, and a gear, various combinations that have already been disclosed may be used, and a detailed description thereof will be omitted. In addition, since the left length adjuster 320-2 may be formed in the same configuration as the right length adjuster 320-1, a detailed description thereof will also be omitted.

The lower portion of the right support 330-1 is connected to the upper portion of the right length adjuster 320-1 and may be moved up and down by the movement of the right length adjuster 320-1. Similarly, the lower portion of the left support 330-2 is connected to the upper portion of the left length adjuster 320-2 and may be moved up and down by the movement of the left length adjuster 320-2.

The lower portion of the right rotator 340-1 may be formed to be vertically rotatable with an upper portion of the right support 330-1, and the upper portion may be formed to be connected to the EM wave collector 350. The right rotator 340-1 may include a motor, a shaft, a gear, and the like, and the motor rotates up and down by a control signal of the wave collecting controller 300 to rotate the EM wave collector 350.

As a specific combination of forming the right rotator 340-1 through a motor, a shaft, and a gear, various combinations that have already been disclosed may be used, and a detailed description thereof will be omitted. In addition, since the left rotator 340-2 may have the same configuration as the right rotator 340-1, a detailed description thereof will also be omitted.

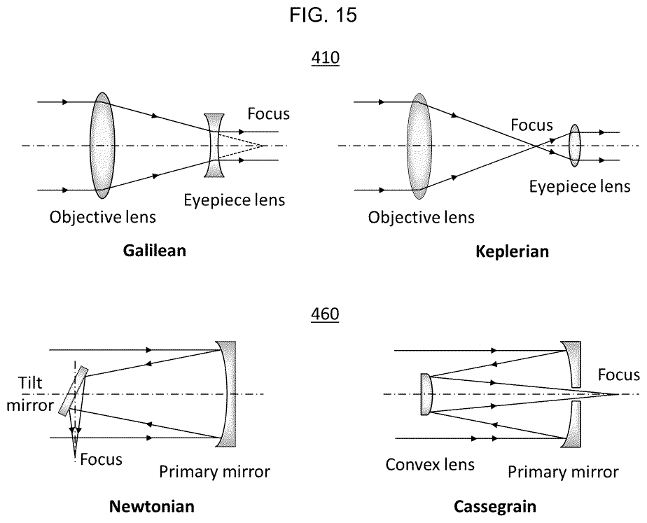

The EM wave collector 350 is a component for collecting and condensing sunlight or external EM waves and may include at least one of a lens and a mirror. An exemplary configuration of the EM wave collector 350 will be described with reference to FIG. 15.

FIG. 15 is a view for illustrating a structure of an EM wave collector according to an embodiment of the present disclosure. In FIG. 15, an exemplary configuration of the EM wave collector 350 configured using the principle of a telescope according to an embodiment of the present disclosure is illustrated.

Telescopes are divided into refracting telescopes and reflecting telescopes depending on whether they are made of lenses or mirrors. There are two types of lenses used in telescopes: convex and concave lenses. A convex lens has a property of collecting sunlight whereas a concave lens has a property of spreading the light. There are convex mirrors and concave mirrors. A convex mirror acts like a concave lens, and a concave mirror acts like a convex lens. That is, a convex mirror has a function of emitting light like a concave lens, and a concave mirror has a function of collecting light like a convex lens.

A refracting telescope 410 is a telescope that uses a convex objective lens to collect light and magnify the image of an object with an eyepiece lens. At this time, according to which lens the eyepiece is used, it can be further divided into Galilean type and Kepler type telescopes. The Galilean type telescope includes a convex objective lens and a concave eyepiece, and the eyepiece is used as a concave lens. The Kepler type telescope uses both the objective lens and the eyepiece as convex lenses so that the focus is placed between the objective lens and the eyepiece.

While a refracting telescope is a telescope made using multiple lenses, a reflecting telescope 460 is a telescope that uses the principle of forming an image using mirrors. Because light or EM wave does not pass through the mirror surface, chromatic aberration does not occur and it has the advantage of being easier to process than a lens. In addition, the reflecting telescope 460 may be exemplified by a Newton type telescope or a Cassegrain type telescope.

The Newtonian reflecting telescope includes a primary mirror with a concave parabolic surface and a tilt mirror or secondary mirror with a planar oblique mirror. This telescope reflects the sunlight or EM waves collected and condensed by the parabolic surface of a primary mirror and then reflected by the flat oblique mirror to form an image outside the barrel, and thus magnifies the image with the eyepiece for observation. Compared to the refracting telescope, the focal length may be made shorter, and manufactured easy at the low price.

In the Cassegrain telescope, a primary mirror is a concave mirror and the aperture is a convex mirror. Sunlight or EM wave entering the primary mirror is reflected first, and then hits a secondary mirror or convex lens. Compared to the Newtonian type telescope, the length of the barrel is shorter and it is easier to balance the weight, but the light path is blocked by the sub-mirror, so the light-converging range and the size of the sub-mirror must be considered when designing. Sunlight is a kind of light belonging to EM waves, and has a property of going straight like all EM waves. In addition, the incident angle of sunlight may change according to time and place.

In the present disclosure, the EM wave collector 350 including at least one of a lens and a mirror refers to a device capable of condensing EM waves such as solar EM waves and irradiating them into the enclosure 150 intensively, and may be configured to include a mirror and/or a lens according to the above-described principle of the telescope. In addition, the EM wave collector 350 may include a parabolic antenna that increases the intensity of the received EM wave by collecting and concentrating the EM wave with the dish-shaped reflective surface at the focal point of the front surface.

Referring back to FIG. 14, the wave collecting controller 300 may include a right pedestal 310-1, a left pedestal 310-2, and a right length to efficiently achieve a process of collecting EM waves according to the incident angle of EM waves such as the sunlight. A control signal may be output to one or more of the right length adjuster 320-1, the left length adjuster 320-2, the right rotator 340-1, and the left rotator 340-2, respectively. Accordingly, the EM wave collector 350 may always face the sun even when the sun 360 moves over time. On the other hand, the specific operation of the wave collecting controller 300 to generate the control signals so that the EM wave collector 350 may always face the sun or an EM wave source is the same as the operation of manipulating the wave collector 350 to tilt toward the sun or an EM wave source. Hence, a detailed description thereof will be omitted.

The wave collecting controller 300 according to an embodiment of the present disclosure may receive a command or a control signal from the control unit 190 to manipulate the wave collecting and condensing structure. In addition, although the EM wave collecting controller 300 and the control unit 190 have been separately described above, they may be configured in the same configuration.

The EM wave pipe 370 may be formed between the wave collector 350 and the enclosure 150 to transmit sunlight concentrated in the wave collector 350 to the enclosure 150. The wave pipe 370 may include at least one of a waveguide, an optical fiber, an optical cable, or a prism (e.g., a pentaprism) and a loop pentaprism in order to efficiently transmit or deliver sunlight or EM wave to the enclosure 150.

The structure of a waveguide may be designed to guide a wave by limiting the propagation of the EM wave or sound wave to one or two dimensions. If there is no waveguide, the amplitude of the wave decreases with the inverse cubic or inverse square law as the wave propagates into three-dimensional space. There are as many waveguides as there are different types of waves, and a hollow conductive metal pipe-type waveguide is generally used. The geometry and material of the waveguide reflect its function. The slab waveguide is defined as one-dimensional and the fiber or channel waveguide is limited to two-dimensional. The frequency of the transmitted wave also determines the material and shape of the waveguide.

An optical fiber that guides high-frequency light or an EM wave is a kind of thin glass or plastic fiber that transmits a light or EM signal. An optical fiber is a circular cross-sectional dielectric waveguide composed of a dielectric that is usually surrounded by another dielectric with a lower refractive index. Fiber optics are most commonly made of silica glass, but other glass materials may be used for specific applications and plastic optical fibers for short-distance applications. The principle of optical fiber is that the inside and outside of the optical fiber are made of glass fibers with different densities and refractive indexes, so that the light or EM wave that enters the optical fiber travels through total reflection.

An optical cable is a transmission medium using optical fibers.

A light pipe is a tube or cylinder of solid material used to guide light or EM wave over short distances. In electronics, plastic light pipes are used to guide light from LEDs on a circuit board to a user interface surface.

A prism is an angled column that refracts and disperses sunlight or EM wave. A prism is usually made of glass, but any material that may pass the wavelength of light or EM wave may be used as a prism. When sunlight, a form of electromagnetic wave, passes through different media such as air and glass, it refracts at the interface between the two media. In this case, the angle of refraction depends on the wavelength (Huygens principle). The refractive index of sunlight or EM wave passing through two transparent media of a specific wavelength has a unique value for each medium (Snell's Law). Under certain conditions, a prism may cause total reflection. Using this property, a prism may be used like a mirror.

Here, total reflection refers to 100% reflection of light or EM waves from a specific surface. For example, if the incident angle of the wave striking the glass is greater than the critical angle, the wave does not pass through the glass and is 100% reflected. This phenomenon is called total reflection. Therefore, the two surfaces are coated like a mirror surface so that light or EM wave may be reflected, and the two transmissive surfaces on the opposite side are mainly coated with an anti-reflection coating to reduce diffuse reflection (or unwanted reflection). The fifth side of the prism may not be used optically, but it is cut at a suitable angle so as not to interfere with the reflection of the two reflective surfaces. By using this principle, a prism may be applied to the formation of the EM wave pipe 370 according to an embodiment of the present disclosure.

Pentaprism is a reflective prism with five sides and is used to refract light or EM wave by 90 degrees. Light or EM wave is reflected twice inside the prism, and an ordinary right-angle prism lets the wave pass through without flipping left and right. Since the incident angle of the wave entering the pentaprism is smaller than the critical angle, the minimum angle that causes total reflection, total internal reflection may not occur.

A roof prism is a type of prism. It is a reflective prism that includes a cross section where two faces meet at an angle of 90°, similar to the roof of a building. A beam of solar or EM waves is reflected by a mirror while it is incident on a prism. Therefore, in order to change the left and right sides of the beam again in the prism, it is a loop pentaprism that replaces one reflective surface of a pentaprism with a loop including two reflective surfaces that meet at right angles.

As described above, the solar or EM waves collected by the wave collector 350 are transmitted to the enclosure 150 through the wave pipe 370, and are applied or irradiated to the source material or the compound for decomposing the material or the compound into the corresponding constituent substances.

In the above, the case where the wave collector 350 collects and condenses solar or electromagnetic waves and transmits them to the enclosure 150 through the wave pipe 370 has been described as an example, but it is self-evident that the wave collector 350 may collect and condense an EM wave other than sunlight. Moreover, the condensed EM wave may be transmitted to the enclosure 150 through the wave pipe 370 like sunlight.

Hydrogen in its natural state is chemically combined with other elements to exist in various forms of compounds. In order to separate hydrogen from the compound, methods such as steam reforming, thermal decomposition, and electrolysis are widely used. As a specific combination for forming steam reforming, pyrolysis, and electrolysis, various combinations that have already been disclosed may be used, and a detailed description thereof will be omitted.

The present disclosure relates to the production of hydrogen and by-products, or less-complex constituent substances by decomposing a more-complex compound for various uses, and more particularly to an apparatus and a method that exploit the resonance effect of electromagnetic waves. Therefore, the present disclosure provides an apparatus and a method capable of more efficiently achieving the goal of decomposition of natural resources or compounds such as methane, propane, petroleum, water, etc. together with steam reforming, pyrolysis or electrolysis.

Embodiments according to the present disclosure are described above. Although the above has been described with reference to the preferred embodiment of the present disclosure, the fact that the present disclosure can be embodied in other specific forms without departing from the intent or scope of the present disclosure may be evident to those skilled in the art. Therefore, the above-described embodiments are to be regarded as illustrative rather than restrictive, and accordingly, the present disclosure is not limited to the above description, but may be modified within the scope of the appended claims and their equivalents.

What is claimed is:

1. An apparatus for decomposing a compound, the apparatus comprising:
an enclosure configured to store the compound;
a wave generator configured to generate at least one electromagnetic wave and apply the at least one electromagnetic wave to the compound in at least one direction; and
a control unit in communication with the wave generator, and configured to determine a frequency of the at least one electromagnetic wave generated by the wave generator.

2. The apparatus of claim 1, wherein the control unit is configured to control the wave generator so that the frequency of the at least one electromagnetic wave is at least one of the natural vibration of a chemical bond of the compound, subharmonics of the natural vibration, and harmonics of the natural vibration.

3. The apparatus of claim 1, wherein the control unit is configured to control the wave generator so that the frequency of the at least one electromagnetic wave is at least one of an intermediate value between the natural vibration of a first chemical bond of the compound and the natural vibration of a second chemical bond of the compound, subharmonics of the intermediate value, and harmonics of the intermediate value.

4. The apparatus of claim 1, further comprising:
a cathode including at least one negative electrode electrically connected and configured to be controlled by the control unit; and
an anode including at least one positive electrode electrically connected and configured to be controlled by the control unit.

5. The apparatus of claim 4, wherein:
the at least one negative electrode and the at least one positive electrode are configured to be immersed in the compound and to be alternately arranged with each other; and
the control unit is configured to apply a voltage equal to or higher than a reference value between the at least one negative electrode and the at least one positive electrode to induce electrolysis.

6. The apparatus of claim 4, further comprising a membrane positioned between the at least one negative electrode and the at least one positive electrode.

7. The apparatus of claim 4, wherein:
the at least one electromagnetic wave is configured to be applied to the compound stored in the enclosure in a direction parallel to at least one of the at least one negative electrode and the at least one positive electrode.

8. The apparatus of claim 4, wherein:
at least one of the at least one negative electrode and the at least one positive electrode defines a hole; and
the at least one electromagnetic wave is configured to pass through the hole.

9. The apparatus of claim 4, further comprising at least one housing configured to surround at least a portion of at least one of the negative electrode and the positive electrode, wherein the housing is configured to collect at least one decomposed constituent produced therein.

10. The apparatus of claim 1, further comprising a magnet disposed adjacent to the compound stored in the enclosure.

11. The apparatus of claim 1, further comprising at least one pipe positioned within the enclosure, wherein the pipe includes at least one injection nozzle configured to spray the compound in the form of mist or small droplets in the enclosure.

12. The apparatus of claim 1, wherein:
the compound includes a hydride or a non-hydride; and
the at least one electromagnetic wave is configured to decompose the compound into hydrogen gas and by-products, or into constituent substances of less complex or smaller units.

13. The apparatus of claim 1, further comprising
a wave collector configured to collect a solar wave or external electromagnetic wave; and
a support configured to support the wave collector in order to apply the solar wave or the external electromagnetic wave to the compound stored in the enclosure, wherein:
the wave collector includes at least one of a lens and a mirror; and
the compound is configured to be decomposed by at least one of the solar wave, the external electromagnetic wave, and the at least one electromagnetic wave generated by the wave generator.

14. The apparatus of claim 13, further comprising at least one wave pipe configured to transmit at least one of the solar wave and the external electromagnetic wave into the enclosure.

15. The apparatus of claim 14, wherein the at least one wave pipe includes at least one of a waveguide, an optical fiber, an optical cable, and a prism.

16. The apparatus of claim 1, wherein the apparatus is configured to be used with at least one of steam reforming, pyrolysis, and electrolysis.
